(19) United States
(12) Patent Application Publication
(10) Pub. No.: US 2025/0097232 A1
(43) Pub. Date: Mar. 20, 2025

(54) SYSTEMS AND METHODS FOR CONFIGURING A DYNAMIC USER INTERFACE FOR AN INSIGHTS BASED WEB PORTAL

(71) Applicant: THE TORONTO-DOMINION BANK, TORONTO (CA)

(72) Inventors: RICHARD DIORIO, CREAM RIDGE, NJ (US); BRET ANDREW GOODMAN, MEDFORD, NJ (US)

(21) Appl. No.: 18/468,537

(22) Filed: Sep. 15, 2023

(51) Int. Cl. H04L 9/40

(52) U.S. Cl. CPC H04L 63/104; H04L 63/102

(57) ABSTRACT

Computerized methods, systems and devices discussed herein enable providing curated customized user interface views of a set of data to a plurality of networked computing devices via a computerized user interface application providing various portal interfaces based on at least an architecture chart defining hierarchy and access for portal groups.

### TECHNICAL FIELD

The present disclosure relates to dynamic user interfaces, and more particularly to configuring a dynamic user interface for an insights based web portal such as for generating web portal content for display.

### BACKGROUND

In the current environment, entities face a complex data environment with redundant and conflicting reporting and presentation of data, particularly data collected across a networked computing environment, such as an enterprise environment, which may have multiple variations of data being aggregated into a single location such as data repository. For example, a web portal such as a web search engine may aim to aggregate data from many computing systems and present a single unified view for a particular data. However, determining a single version of truth, avoiding data redundancies and presenting such data present a complicated and inefficient problem to solve. Typically, entities are not aligned on key metrics and definitions for determining a single source of data and there are limited self-service abilities or opportunities to deep dive into metrics of interest.

Typically, such determination needs to be manually identified and associated with each user. However, browsing and accessing large amounts of data in a networked enterprise environment presents a challenging task for users who have difficulty locating and navigating desired data in large data environments, such as across an entire entity data system.

### SUMMARY

Accordingly, in at least some aspects, there remains a need for a portal ecosystem for users within an entity with end-to-end, trusted insights from all entity data systems (e.g. servers, repositories, etc. in a networked entity environments) that result in presenting a customized insights based web portal to drive improved decisions based on navigating the user interface portal in a data driven environment. There is thus provided, in at least some aspects, a data driven web based insights portal within a portal ecosystem that delivers information in a useful and visually easily navigable user interface manner.

In one aspect, there is provided a series of web portals, creating curated views and provides a platform for integrating features such as data forecasting and sharing insights from different support and insight groups, the web portals being interconnected and integrated to provide a single source of truth.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computing device for providing curated customized views of a set of data to a plurality of networked computing devices via a computerized user interface application. The computing device also includes receiving an input, from a database, of an organization chart providing a branched architecture within an entity for a plurality of users associated with the plurality of networked computing devices; determining from the organization chart each type of user from the plurality of users associated with each of the networked computing devices and thereby accessing a corresponding access chart for the plurality of users may include access privileges for the users according to the type of user; determining from the organization chart an associated grouping of the user to other similar users within the entity for each of the plurality of users and thereby accessing content interests specific for both the user and the other similar users; applying the organization chart to a user interface module for generating a series of curated customized views of the data for each user being a subset visual representation of the data for the computerized user interface application based on the access privileges and the content interests for the user and the other similar users, where the curated customized views provide slices of information being related content from the data; and provide the series of curated customized view of the data across a networked environment, via the user interface application, for different types of users for display on the plurality of networked computing devices. Other embodiments of this aspect include corresponding computer systems, apparatus, and computer programs recorded on one or more computer storage devices, each configured to perform the actions of the methods.

Implementations may include one or more of the following features. The computing device wherein the curated customized views for a user have at least some screens of content overlapping with content in customized views of the data for another user of a different associated grouping for an entity based on the access privileges. The instructions cause the computer to determine a series of curated customized views further may include, via the user interface application, allowing one particular type of user accessing from one of the plurality of networked computing devices and having a higher access privilege to navigate to and view a first set of customized views for the particular type of user and a second set of other customized views for other types of users having a lower access privilege. Via the user interface application, the instructions further cause the computer to present a hyperlink on the first set of customized views for the particular type of user to navigate to connected view pages of the other types of users to trigger displaying the second set of other customized views. The instructions further cause the computer to predict the content interests of each user based on tracking, via the user interface application, online user behavior with a computing device. The online behavior may include social media feed associated with the user and prior content navigated to by each user via the user interface application. The instructions causing the computer to determine the type of user may include determining an associated role within an entity and retrieving associated digital access levels for accessing each type of a plurality of types of potential data from the set of data. The instructions causing the computer to generate the curated customized views for a user associated with one of the plurality of networked computing devices further may include generating at least some screens of content overlapping with content in customized views of the data for another user of a different associated group for an entity based on the access privileges. Implementations of the described techniques may include hardware, a method or process, or computer software on a computer-accessible medium.

One general aspect includes a method for providing curated customized views of a set of data to a plurality of networked computing devices via a computerized user interface application. The method also includes receiving an input, from a database, of an organization chart providing a branched architecture within an entity for a plurality of users associated with the plurality of networked computing devices; determining from the organization chart each type of user from the plurality of users associated with each of the networked computing devices and thereby accessing a corresponding access chart for the plurality of users may include access privileges for the users according to the type of user; determining from the organization chart an associated grouping of the user to other similar users within the entity for each of the plurality of users and thereby accessing content interests specific for both the user and the other similar users; applying the organization chart to a user interface module for generating a series of curated customized views of the data for each user being a subset visual representation of the data for the computerized user interface application based on the access privileges and the content interests for the user and the other similar users, where the curated customized views provide slices of information being related content from the data; and providing the series of curated customized view of the data across a networked environment, via the user interface application, for different types of users for display on the plurality of networked computing devices. Other embodiments of this aspect include corresponding computer systems, apparatus, and computer programs recorded on one or more computer storage devices, each configured to perform the actions of the methods.

One general aspect includes a non-transitory computer readable medium having instructions tangibly stored thereon for providing curated customized views of a set of data to a plurality of networked computing devices via a computerized user interface application. The non-transitory computer readable medium also includes receive an input, from a database, of an organization chart providing a branched architecture within an entity for a plurality of users associated with the plurality of networked computing devices; determine from the organization chart each type of user from the plurality of users associated with each of the networked computing devices and thereby accessing a corresponding access chart for the plurality of users may include access privileges for the users according to the type of user; determine from the organization chart an associated grouping of the user to other similar users within the entity for each of the plurality of users and thereby accessing content interests specific for both the user and the other similar users; apply the organization chart to a user interface module for generating a series of curated customized views of the data for each user being a subset visual representation of the data for the computerized user interface application based on the access privileges and the content interests for the user and the other similar users, where the curated customized views provide slices of information being related content from the data; and provide the series of curated customized view of the data across a networked environment, via the user interface application, for different types of users for display on the plurality of networked computing devices. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features of the disclosure will become more apparent from the following description in which reference is made to the appended drawings wherein:

FIG. 1 shows an exemplary computing environment in accordance with one or more aspects of the present disclosure;

FIG. 2 is a diagram of an exemplary computer system, e.g. a portal server, for use in the computing environment in accordance with one or more aspects of the present disclosure;

FIG. 3 is a diagram of an exemplary organization chart having a tree based structure in accordance with one or more aspects of the present disclosure;

FIGS. 4-6 are example screen shot views or portions thereof of the web based insights portal application, in accordance with one or more aspects of the present disclosure; and

FIG. 7 is a flowchart illustrating one example of a method of operation executed by the portal server device for providing curated customized views of a set of data to a plurality of networked computing devices via a computerized user interface application.

### DETAILED DESCRIPTION

In at least some aspects, various embodiments enable an improved portal ecosystem providing an improved user experience in visually navigating interconnected portals which have content presented thereon specifically curated based on user profiles within a networked entity of computing systems, servers, web pages, resources, databases and other such systems.

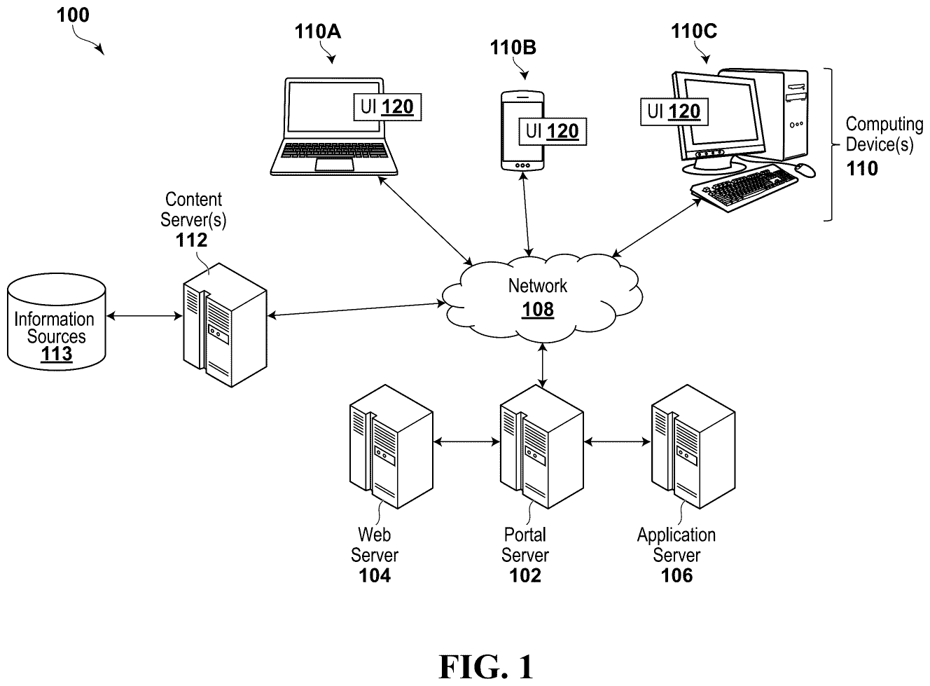

Referring to FIG. 1, there is shown a portal ecosystem environment, as a computing environment 100 configured to generate insights based web portals, which may be interconnected to one another and specifically visually customized on a user interface for determining and presenting content specifically based on particularities of the environment such as user profiles and/or roles of users within an entity as determined from a hierarchical access chart including access rights.

The environment 100 is a portal ecosystem which generally comprises a portal server 102, a web server 104, an application server 106, and a content server 112 cooperating across a network 108 to deliver a customized web based insights portal having curated user interface views visually presenting interconnected data views, shown as a user interface (UI) 120 to one or more of a plurality of computing devices 110 (shown as a first computing device 110A, a second computing device 110B, a third computing device 110C) within an entity environment.

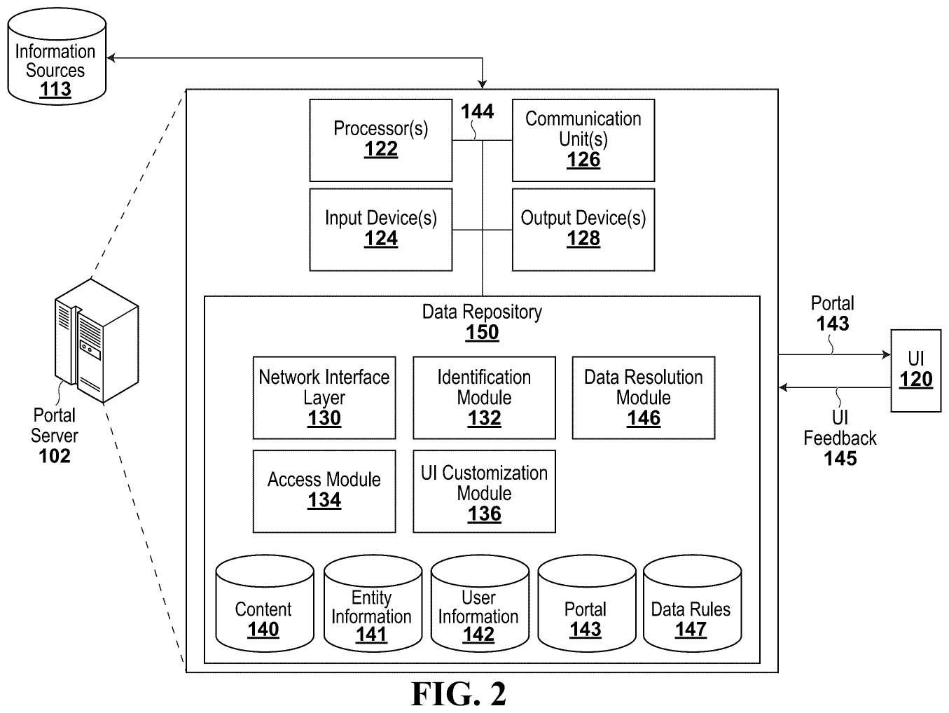

Referring to FIG. 2, shown is an exemplary computer system, shown as the portal server 102, with which embodiments consistent with the present disclosure may be implemented.

Generally and referring to FIGS. 1 and 2, in at least some embodiments, the web portal, or the portal server 102 as described herein is a computer-implemented device or server comprising a network-accessible interface (e.g. see network interface layer 130 in FIG. 2) accessible via a web browser or similar client software provided via one or more networked computing devices 110.

The interface provided by the network interface layer 130 is configured to facilitate access to a plurality of digital resources, services, and digital information sources, shown as digital information sources 113 from various remote locations over a computer network, such as the computing network 108 or the Internet. In one aspect, the information sources 113, may comprise a plurality of digital resources, services, web sites, web pages, and other data of interest, as accessible via a content server 112 and the network interface layer 130 of the portal server 102.

The web portal system provided via the portal server 102 is configured to provide users of computing devices 110, such as via the network interface layer 130, with a centralized point of entry to access, interact with, and manage said digital resources, services, and information sources 113 via a portal 143. The portal server 102 is configured to drive a single version of the truth via a series of portals which may be presented via portal 143 on user interface(s) 120.

In at least some aspects, the portal 143, may be further personalized and/or customized via user input received on the user interface 120. Generally, in some aspects, the portal may comprise one or more portlets to display one or more digital content accessed via the computing environment 100 from a content database or server, such as the content server 112 and/or content 140 locally stored on the portal server 102.

Referring to FIGS. 1 and 2, in at least some aspects, the web portal (e.g. see portal 143 to be presented on user interface 120) provided by the portal server 102 may require user identification via an identification module 132, and/or authentication via an authentication or access module 134, and may offer personalized visual user interface content for each portal driving curated screen views (e.g. content 140) via the UI customization module 136 and functionality based on user profiles and preferences (e.g. user information 142), user roles within an entity or organization (e.g. entity information 141 such as organization chart or access chart) and/or within a networked computer system, such as the computing environment 100 comprising disparate information sources 113.

In at least some aspects, the web portal, shown as portal 143 in FIG. 2, provided by the portal server 102, may further include computerized communication tools, user interface customization options, and integration capabilities to enhance user interface experience and efficiency via the UI customization module 136 in accessing and interacting with said digital resources, services, and information sources, such as the information sources 113 across the computing environment 100 of FIG. 1.

In at least some aspects and referring to FIGS. 1 and 2, the computerized system may provide a computing environment 100 comprising a portal server 102 in communication with a web server 104 and an application server 106, the portal server 102 to generate a customized user interface (e.g. UI 120) of a computer application and/or portal 143 for display on a computing device, such as computing devices 110 providing reliable digital content via a series of interconnected portals driving a single version of truth whereby the portals are dynamically generated such as to shift priorities based on determined user needs as may be derived from user information 142 and/or entity information 141.

The portal 143 (or series of portals) generated provide a single source of truth visually generated content 140 for content accessed across a networked environment and various sources of data) and adjust content delivered (e.g. filtering or personalizing content 140) based on dynamically determining user information 142 such as role of users within an entity, type of access associated with the role of the user for the portals (e.g. as determined from an organization chart, access chart or other hierarchical chart linking various users of the computing environment 100 and associated access rights for the particular content of interest), type of information of interest for the particular group of user determined for a particular user of the computing device 110. For example, the identification module 132 may be configured to determine a role of the user within a distributed system of users in the computing environment 100 and cooperate with the access module 134 to determine authentication and/or associated digital access rights and/or user visual digital content preferences for the portal(s) such as by accessing organizational chart providing a branched architecture of users within the networked computing environment (e.g. provided in the entity information 141) further defining digital access hierarchy of users for a particular web portal application such as portal 143, accessed from a computer repository, such as a data repository 150.

Preferably, the access module 134 is provided to determine a digital access framework for customizing and retrieving the relevant content 140, including various screen views and screen display elements and underlying content on the generated portals 143 based on a predefined or provided architecture of users of the computing devices 110 such as defining access rights of users (or types of users) such as to allow navigation between specific screens or sequence of screens linked together to create a series of branched portal which can be navigated to replicate or follow the branched architecture of the user hierarchy and/or access rights (e.g. organization charts indicating roles or types of roles of each user and corresponding access rights). An example visual display of such

In at least some aspects, the web portal 143 provides a single source of digital truth of the digital resources, content, and/or digital services of interest across an enterprise network such as the computing environment 100. The single source of truth may refer to a central, authoritative data or information repository, such as the content server 112 that serves as the definitive reference point for all data, content, and information within an entity or system, such as the computing environment 100.

In at least some aspects and referring to FIGS. 1 and 2, the portal server 102 as described herein may be a type of web server (e.g. may be separate or combined with the web server 104) that allows users of the connected computing devices 110 to access different types of content and applications, such as information sources 113, through a single, unified interface provided via the portal 143 for display on a client user interface 120 delivered onto one or more connected computing devices 110.

The portal server 102 as shown in FIGS. 1-2, may provide a web or network gateway or a “portal” to other web resources, such as web pages, applications, and services such as information sources 113, as may be available via one or more networked computing devices of remote devices such as the content server 112. The web server 104, as described herein, may in some aspects be a software program or server that serves web pages and other web content over the internet, or other network such as the network 108 to one or more computing devices 110. It receives requests from client devices (such as web browsers) on computing devices 110 and sends back the appropriate response (such as a web page or an error message).

An application server 106, as described herein may be a software program or server that provides the middleware and logic for an application, such as the insights based web application described herein accessible via the portal 143. The application server 106 may logically reside between (or be otherwise coupled to) the web server 104 and a database server, such as a content server 112, and handles tasks such as user authentication, session management, and data processing. Alternatively, such tasks may be handled in cooperation with the portal server 102 such as via the identification module 132 and/or access module 134 and/or UI customization module 136.

Conveniently, in some aspects, the web server 104, the application server 106, and the portal server 102 may all have different roles and/or overlapping roles which cooperate together to deliver web-based content and applications, such as via the portal 143 to users of associated computing devices 110 on the user interface 120.

In one example implementation, the portal server 102, may use a web server 104 to serve up web pages and web content for the portal 143, and an application server 106 to handle functionality such as but not limited to: application logic, business rules, authentication rules, and content data processing.

Referring again to FIGS. 1-2, in one aspect, the computing environment 100 provides a customized analytics solutions for users of the computing devices 110 to aid them in visualizing and deciphering large amounts of data efficiently and navigating same for realizing a particular purpose. The portal server 102, conveniently allows creating trusted, timely visual user interface insights from various disparate digital sources across the computing environment 100 of an entity. The user interface 120 further allows visually exploring content of interest and performance of products (e.g. e-commerce products or other digital products or resources) within the domain.

The computing environment 100 provides a computerized portal ecosystem with hyperlinks, weblinks, visual links, or other visual graphical user interface (GUI) elements which once engaged allow a user to quickly navigate (e.g. with a single click) to different visual content of interest (or other digital screens providing alternate portal views) which may be allowed for viewing by the access module 134 initially determining the access rights and/or organization structure of the users of the entity.

Conveniently, in at least one aspect, the portal server 102 enables browsing desired content across the networked computing environment 100 by addressing technical issue that there may be various sources of information, such as various different dashboards and digital reports which may cause difficulty to find a single version of the truth distributed across a lot of artifacts and thereby cause difficulty in determining accuracy of the data. The artifacts may be tangible by products produced during development of the portal application for generating the portal 143. Each customized view generated by the portal 143 on the user interface 120 will display a visual link which when selected, triggers, jumping or navigating to different content thereby driving a single version of the truth.

Generally, in web server systems and networked computing systems, data may be distributed across multiple servers and databases such as the computing environment 100, potentially leading to data inconsistencies, data discrepancies, and errors when multiple computing sources provide conflicting or outdated information. The computing environment 100 is configured via the portal server 102, in at least some implementations, via a data resolution module 146 for establishing and determining a single source of truth for use by the UI customization module 136 which is critical to maintaining data integrity, reducing redundancy, and enhancing the overall reliability of web-based services provided by the portal 143 application.

Referring again to FIG. 2 which is a diagram illustrating in block form an example computing device, e.g. a portal server 102 for providing curated customized views of a set of portal related data (e.g. information sources 113) to a plurality of networked computing devices, e.g. computing devices 110 via a computerized user interface application shown as the portal 143 and for use in the communication system and environment of FIG. 1.

The portal server 102 includes at least one processor 122 (such as a microprocessor) which controls the operation of the portal server 102. The processor 122 is coupled to a plurality of computing components and data stores via a communication bus or channel, shown as the communication channel 144.

The portal server 102 further comprises one or more input devices 124, one or more communication units 126, and one or more output devices 128. The portal server 102 may receive as input a plurality of information sources 113, user input feedback 145 from a user interface 120 and generate a portal 143 based web application for one or more connected computing devices such as computing devices 110 shown in FIG. 1. The portal server 102 also includes one or more data repositories 150 storing one or more computing modules and components such as a network interface layer 130, an identification module 132, an access module 134, a UI customization module 136, a data resolution module 146, one or more data stores comprising: content 140, entity information 141, user information 142, portal 143, and data rules 147.

Communication channels 144 may couple each of the components for inter-component communications whether communicatively, physically and/or operatively. In some examples, communication channels 144 may include a system bus, a network connection, an inter-process communication data structure, or any other method for communicating data.

Referring to FIGS. 1 and 2, one or more processors 122 may implement functionality and/or execute instructions within portal server 102. The processor 122 is coupled to a plurality of computing components via the communication bus or communication channel 144 which provides a communication path between the components and the processor 122. For example, processors 122 may be configured to receive instructions and/or data from storage devices, e.g. data repository 150, to execute the functionality of the modules shown in FIG. 2, among others (e.g. operating system, applications, etc.). Portal server 102 may store data/information as described herein for the process of generating a portal 143 which may be delivered to one or more computing devices, such as computing device 110, by way of UI 120. Some of the functionality is described further herein.

One or more communication units 126 may communicate with external devices via one or more networks (e.g. communication network 108) by transmitting and/or receiving network signals on the one or more networks. The communication units may include various antennae and/or network interface cards, etc. for wireless and/or wired communications.

Input devices 124 and output devices 128 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 144).

The one or more data repositories 150 may store instructions and/or data for processing during operation of the portal server 102. The one or more storage devices may take different forms and/or configurations, for example, as short-term memory or long-term memory. Data repositories 150 may be configured for short-term storage of information as volatile memory, which does not retain stored contents when power is removed. Volatile memory examples include random access memory (RAM), dynamic random access memory (DRAM), static random access memory (SRAM), etc. Data repositories, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Portal 143 may comprise an application (whether native or browser based) and may be configured to obtain input (e.g. UI feedback 145) to perform an action. An action herein may be construed broadly as an operation of portal server 102, or modules contained therein

Referring again to FIG. 2, it is understood that operations may not fall exactly within the modules 130, 132, 134, 136, and 146 such that one module may assist with the functionality of another.

Referring again to FIGS. 1 and 2, the data resolution module 146 may comprise computer instructions tangibly stored on a memory such as the data repository 150 which when executed by a processor 122 and/or a hardware module are configured for resolving data conflicts and inconsistencies by comparing data from multiple sources. Additionally, in at last some aspects, the data resolution module 146 is configured to access and/or retrieve set of predefined criteria, algorithms, or rules such as may be stored within data rules 147 that determine which data source within a networked computing environment (e.g. content server 112 associated with information sources 113) is designated as the single source of truth based on factors such as but not limited to, data freshness, reliability, and source authority, etc.

In at least one aspect, the portal 143 is dynamically generated via the portal server 102 and as user interests change (as may be stored within user information 142 and/or entity information 141) so will the content 140 retrieved for the portal 143.

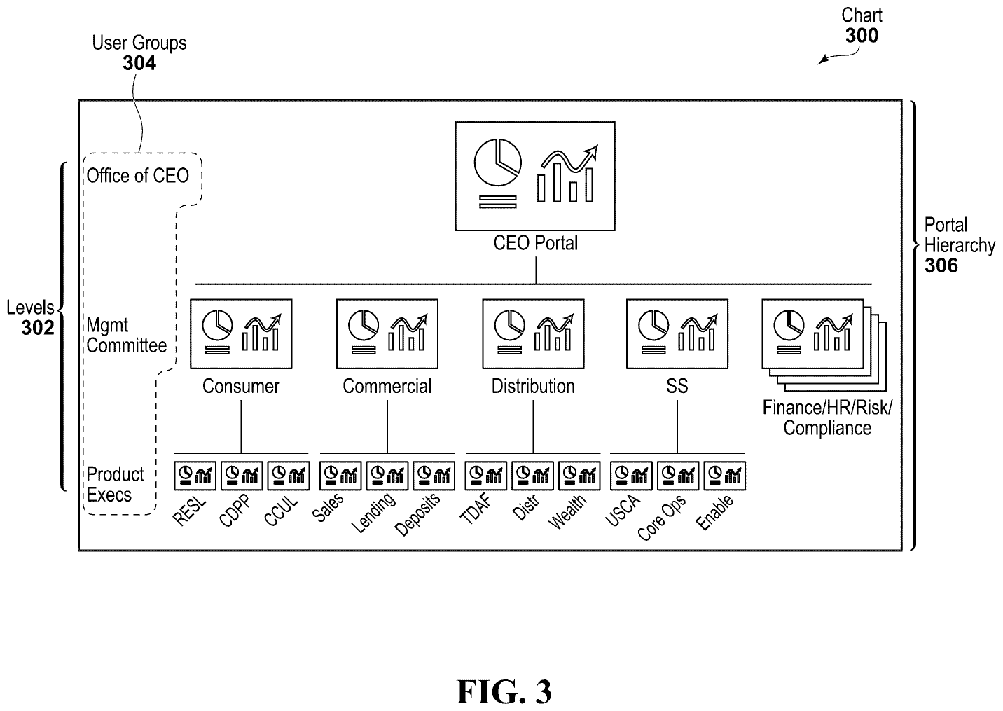

Additionally, in at least some implementations, the user content accessed from the content 140 and displayed in the UI 120 is based on both the interests for the user as retrieved from the user information 142 and based on computing system intelligence for a particular user's respective role or functionality within an organization and associated access rights/interests (e.g. as determined from the UI customization module 132 accessing an organization chart from the user information 142 and/or entity information 141 as visualized the chart 300 in FIG. 3 illustrating a branched access architecture).

Referring to FIG. 3, there is illustrated an example chart 300 illustrating a branched architecture diagram for an organization or entity chart depicting user roles or responsibilities within an entity as organized into various branches or levels. Such chart 300 may be stored on the data repository 150 for use by the portal server 102 for determining curated customized portal screens and content for a particular user. For example, each branch may represent a different level of authority, or specialization within an entity and thus be used, by the access module 134 to determine associated portal access rights for the portal 143. Such organization chart 300 may be stored within the entity information 141. For example, the hierarchy levels 302 of the organization chart may be each associated with a different level of access via the access module 134, e.g. the higher up the level in the hierarchy, the broader the access rights as opposed to lower levels having less access to the portal 143 various screen and data sets available for viewing.

In one example implementation, once the identification module 132 identifies a type of a particular user (e.g. associated role within an entity) accessing a computing device 110, such as for accessing the portal application via web sites and/or web pages or native application made available via the portal server 102 to access one or more portal screen depicting a particular data set of information and associated insights, the identification module 132 then maps such user information to the organization chart 300. The access module 134 then determines from the information associated with mapping a particular requesting user (e.g. requesting access to the insights portal application) to the organization chart such as but not limited to: hierarchy level(s) assigned to the user and comparison to other hierarchy levels; role of user within entity; user clustering relative to other users (e.g. user associated with a particular area within an entity); digital connectivity relationship of user relative to other users within the computing environment 100, the associated access levels derived from the organization chart. Thus, the chart 300 may allow the portal server 102 to determine software access permission and compliance. Furthermore, in at least some aspects the access module 134 utilizes a branched architecture diagram (e.g. as shown in the example of FIG. 3) for an entity used to visually define and map out role, hierarchy, connectivity and/or relationship of networked users within a computing environment for an entity, such as the computing environment 100 to associate specific application access to such as the insights portal application to different roles, positions, relationships or levels within the hierarchy. For instance, each subset of the data to be presented or each subset of potential user interface screens for the portal or subset of GUI elements for the insights portal application may be associated with specific access control rules or criteria as may be stored within the access module 134 for determining curated views for a particular user (or group of users having similar profiles within the chart 300) via the UI customization module 136 and the content 140.

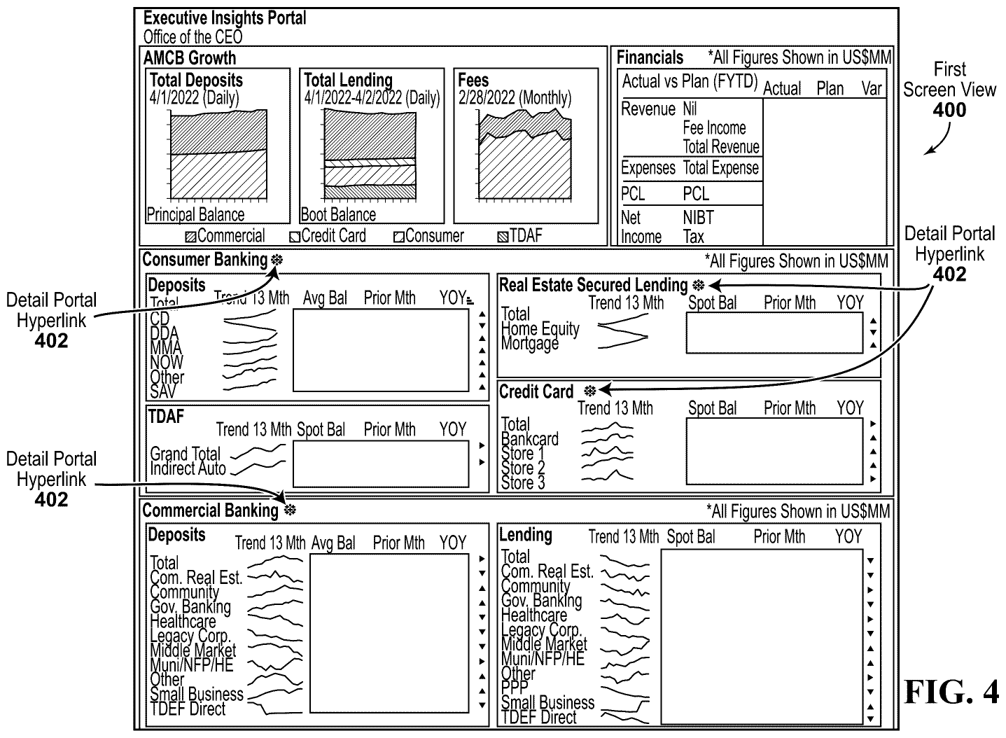

Referring to FIGS. 4-6 shown are example screen shot views of the insights portal application or interface, e.g. portal 143 provided to one or more computing devices 110 via the user interface 120 from the portal server 102.

In at least some examples, each screen presented on the portal 143 user interface may show at least some portions of shared artifacts, functions and shared data pointing to the same overall data structure behind this). As described herein, in at least one aspect, the portion of the data shown in a given screen may depend upon, but not limited to: the metadata associated with the user accessing the screen (e.g. the user profile), role of the user within an entity and classification of the user as compared to the hierarchical entity chart (e.g. the chart 300 defining which classification level a user falls into) and the associated digital access metadata (e.g. which portions of the overall data, functionality, views etc. does the user have access to). The digital access metadata may be associated with the determining how the user characteristics fit within the hierarchical chart.

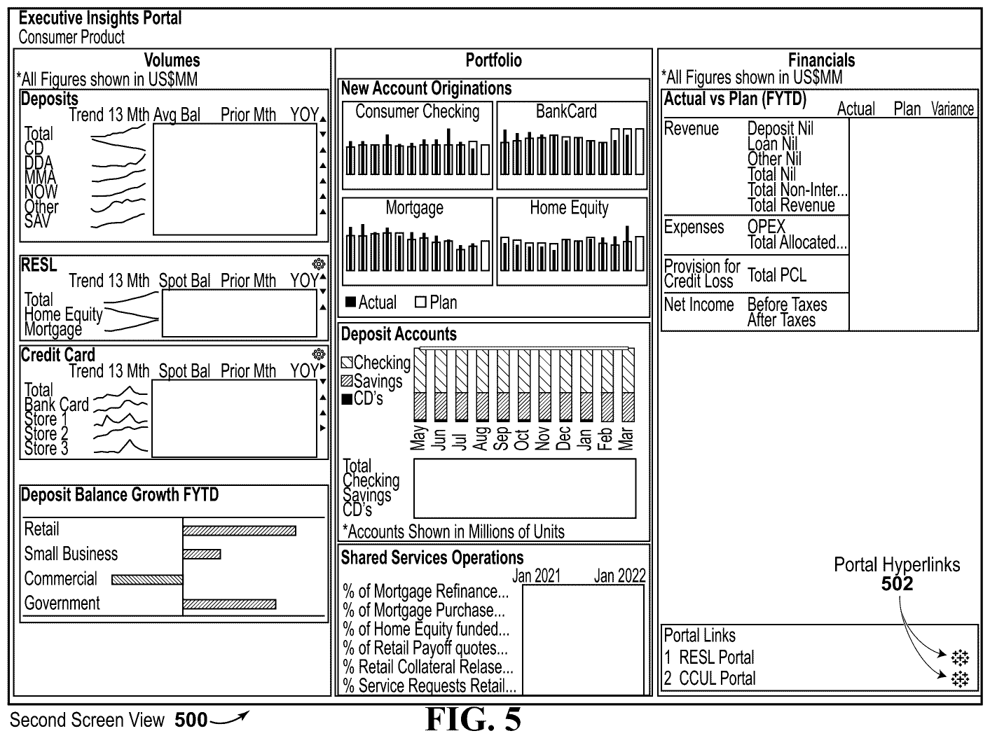

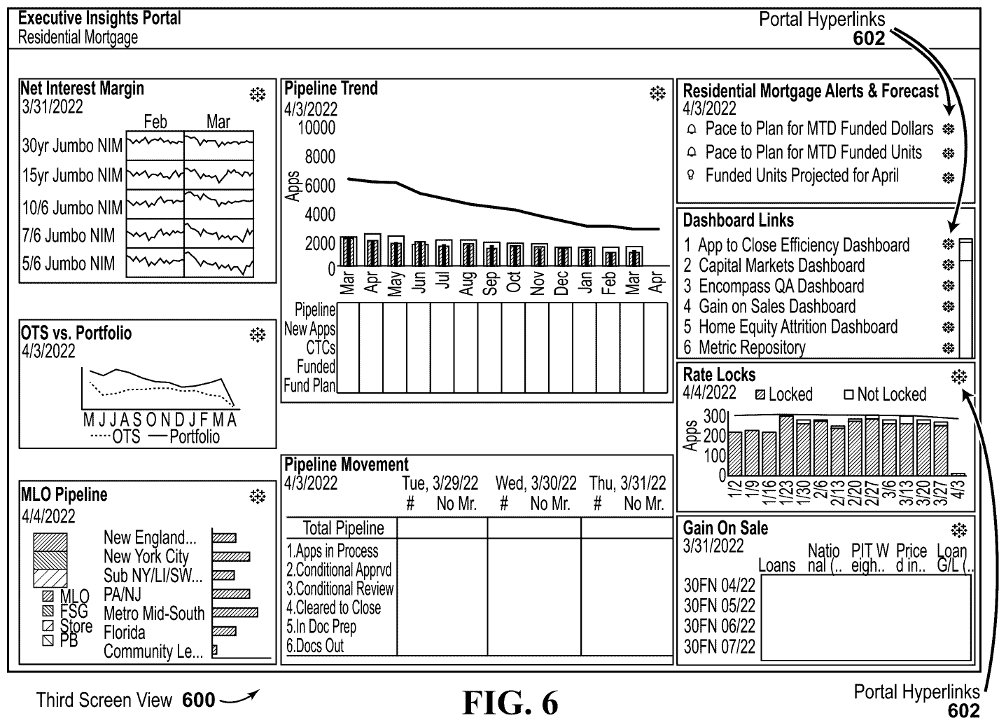

The portal 143 screen displays as illustrated in the examples of FIGS. 4-6, may display and provide hyperlinks to connect a screen containing one subset of content to another screen containing a different set of content navigated via a single click (e.g. upon the access module 134 confirming that access rights are met). An example of the portal hyperlinks 502 shown in FIG. 5 illustrate that selecting one of the hyperlinks may trigger navigation to a different portal, e.g. “RESL portal”. Further examples of screen hyperlinks are illustrated in the third screen view of a different portal in FIG. 6 having screen hyperlinks 602.

In one aspect, one portal screen such as that illustrated in the first screen view 400 may illustrate a summary view of the insights on a single screen of the user interface 120 and each portion of the summary may include a hyperlink, shown as a detail portal hyperlink 402 which allows navigation to a further screen for that selected portal to view additional content contained thereon for that subset of content.

Conveniently, this provides, in at least some aspects, an improved user interface and provides a portal platform where the whole of the content and functionality provided is greater than the sum of the parts.

Additionally, in at least some aspects, the portal server 102 is configured such that each screen content is further curated by monitoring user behaviors (e.g. social media feeds) associated with the computing devices 110 to determine specific and relevant content to generate on the portal 143 (e.g. from the content 140) to be presented on a screen for a particular type of user (e.g. given role within an entity) or a particular user for consumption and navigation via the user interface 120. This allows insights based portal browsing in accordance with various embodiments in an efficient manner while protecting the underlying data for display on the user interface.

In at least some aspects, the access module 134 discussed with reference to FIGS. 1 and 2 is configured to control and manage access to content for the portal 143 based on an entity architecture (e.g. as stored within entity information 141) and synchronize the view displayed with the data retrieved from the access rights from the entity architecture.

In at least some aspects, the portal 143 application generated by the portal server 102 of FIGS. 1-2, provides forecasting and advanced analytics to share insights or contents of interest to different subsets of users or groups of users via respective computing devices (e.g. such groups may be determined via the organization chart, such as the chart 300).

Generally, there is provided a portal ecosystem which provides end to end trusted insights as shown in FIG. 1.

For example, in FIG. 3, the chart 300 shows the organization hierarchical chart used by the access module 134 for defining access to various portals available by the UI customization module 136. Referring to FIG. 3, shown are various levels of access to the portals (e.g. levels 302). In the example diagram of FIG. 3, the top portal level shown as the CEO portal is shown at the top with the user group of access shown as “Office of the CEO”. Next down in the portal architecture chart, e.g. chart 300, which is a pyramid branched tree structure illustrating hierarchy of access, are the consumer, commercial, and distribution portals located further down in the hierarchy tree of access. The second tier of portals may be accessed by a second group of users, shown as “Management committee”. As shown in FIG. 3, below that there may be a third tier of access that is for a third class of users, for example but not limited to: product executives who have access to third tier portals including but not limited to: real estate, secured lending, credit cards and different product level views for commercial distribution. It will be understood that while portals for financial applications may be discussed as examples herein, the disclosure is not limited to such examples and other applications of web portals which provide insights may be envisaged.

Conveniently, in at least some aspects, the tiers of access shown in FIG. 3 are integrated together to form an improved ecosystem which delivers consistent and reliable data for use on various portal interfaces.

In one example and as shown in the screen shot example views of FIGS. 4-6, a user having appropriate access rights (e.g. “CEO”) may navigate from an initial top tier, portal view generated by the portal 143 on the user interface 120, customized for the CEO to a second tier portal view for other portals, e.g. commercial portal, where there are same artifacts and same data, pointing to the same data, congruity, and data structure behind this that integrates the certain pieces via the portal server 102 and the data resolution module 146.

Further conveniently, by clicking or selecting the different data links shown as the hyperlinks on FIGS. 4-6, the underlying data does not change. That is, data in one page may be hyperlinked to another allowing navigation between portals and respective content to create a portal platform which bring in more content and surfaces it up via the UI customization module 136 at different layers

Thus the UI customization module 136 is configured, in some aspects to present content in a portal screen (e.g. FIGS. 4-6) that is curated based on a type or group of user. For example, the UI customization module 136 may be configured to receive tracking data and/or track behavioral online activity data to determine whether data being served on the UI 120 interface is consumed (e.g. as tracked via UI feedback 145 shown in FIG. 2) and thus modify the data components displayed based on prior consumption and other network behaviors (e.g. social media engagement).

From a user interface standpoint, one example problem to be addressed by the portal server 102 and the computing environment 100 is how to take data available as a whole and split it into various portals and how to decide where to split it up.

As shown in the chart 300 of FIG. 3, a user higher up in the branched tree hierarchy may have access to all of the portals for users below it in the hierarchy. Thus, the portal server 102 may be configured via the access module 134 such that users at the top of the hierarchy chart can look down but not look up in the tree structure of portals. In one example, the CEO portal shown in FIG. 4 has links to all other portals available in the detail portal hyperlink 402 but another user in the computing environment 100 who is in the second tier of access in FIG. 3 may have access to the second tier of portals, e.g. the consumer portal in FIG. 5 shown as the second screen view 500 having portal hyperlinks 502, but may be unable to look up to the first tier of portals, e.g. the CEO portal (FIG. 4).

Using the defined architecture (e.g. chart 300 in FIG. 3), users of the computing devices 110 would have access, via the portal server 102, to content presented on portal screens based on role based access which would allow easier access to information along with consistency of the data shown.

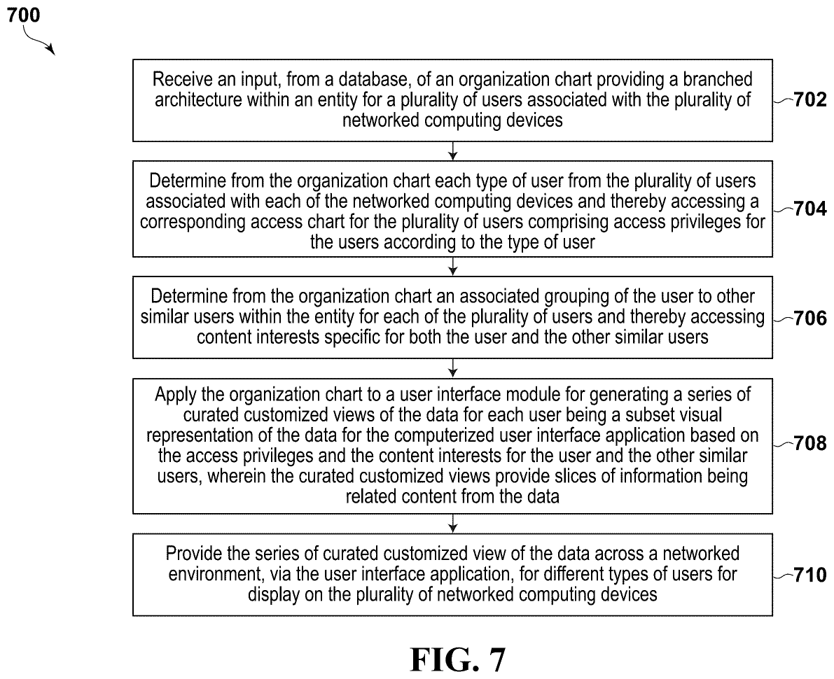

FIG. 7 is a flowchart of operation 700 which may be performed by a specifically configured computing device, shown as the portal server 102 of FIGS. 1-2 in communication with the web server 104, application server 106, content server 112 and the computing device 110 across a computing network 108. The portal server 102 may comprise a processor configured to communicate with a display to generate a web based portal 143 on a graphical user interface (GUI) 120 where the computing device has an input device to receive UI feedback 145 interacting with the user interface and wherein instructions (stored in a non-transient storage device), which when executed by the processor, configure the computing device to perform operations such as the operations 700.

Referring to FIGS. 1, 2 and 7, at a first operation 702, the operations provide a user interface to receive an input via a database using a network interface layer 130 (e.g. entity information 141 and user information 142 on data repository 150 which may be received across the network 108) of an organization chart (e.g. example chart 300 in FIG. 3) providing a branched architecture of portal hierarchy within an entity for a plurality of users associated with the plurality of networked computing devices 110 and associated users.

At a second operation 704 following the first operation 702, operations of the portal server 102 include determining from the organization chart, via the identification module 132, each type of user from the plurality of users (e.g. user of computing device 110 associated with “consumer” group of users) associated with each of the networked computing devices 110 and thereby accessing a corresponding access chart (e.g. portal hierarchy 306 which may be used to determine corresponding access) for the plurality of users comprising access privileges for the users according to the type of user.

At a third operation 706, operations of the portal server 102 include determining from the organization chart, e.g. chart 300, and via the access module 134, an associated grouping of the user to other similar users within the entity for each of the plurality of users (e.g. user groups 304 associated with different levels of hierarchy in the branched tree architecture) and thereby accessing content interests such as accessed from the content 140 specific for both the user and the other similar users. Similar to that described earlier, the portal server 102 may track UI feedback 145 to determine prior content of interest for similar users.

At a fourth operation 708, operations of the portal server 102 include applying the organization chart to a user interface module, e.g. via the UI customization module 136, for generating a series of curated customized portal 143 views of the data for each user being a subset visual representation of the data for the computerized user interface application based on the access privileges and the content interests for the user and the other similar users, wherein the curated customized views provide slices of information being related content from the data (e.g. see FIGS. 4-6).

At a fifth operation 710, operation of the portal server 102 provide the series of curated customized view of the data, e.g. output as portal 143 across a networked environment such as a network 108, via the user interface application shown as UI 120, for different types of users for display on the plurality of networked computing devices 110.

In one or more examples, the functions described may be implemented in hardware, software, firmware, or combinations thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including such media as may facilitate transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

Furthermore, the elements depicted in the flowchart and block diagrams or any other logical component may be implemented on a computerized machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

One or more currently preferred embodiments have been described by way of example. It will be apparent to persons skilled in the art that a number of variations and modifications can be made without departing from the scope of the disclosure as defined in the claims.

What is claimed is:

1. A computing device for providing curated customized views of a set of data to a plurality of networked computing devices via a computerized user interface application, the computing device comprising a processor, a storage device and a communication device wherein each of the storage device and the communication device is coupled to the processor, the storage device storing instructions, which when executed by the processor, configure the computing device to:
receive an input, from a database, of an organization chart providing a branched architecture within an entity for a plurality of users associated with the plurality of networked computing devices;
determine from the organization chart each type of user from the plurality of users associated with each of the networked computing devices and thereby accessing a corresponding access chart for the plurality of users comprising access privileges for the users according to the type of user;
determine from the organization chart an associated grouping of the user to other similar users within the entity for each of the plurality of users and thereby accessing content interests specific for both the user and the other similar users;
apply the organization chart to a user interface module for generating a series of curated customized views of the data for each user being a subset visual representation of the data for the computerized user interface application based on the access privileges and the content interests for the user and the other similar users, wherein the curated customized views provide slices of information being related content from the data; and
provide the series of curated customized view of the data across a networked environment, via the user interface application, for different types of users for display on the plurality of networked computing devices.

2. The computing device of claim 1, wherein the curated customized views for a user have at least some screens of content overlapping with content in customized views of the data for another user of a different associated grouping for an entity based on the access privileges.

3. The computing device of claim 2, wherein the instructions causing the computer to determine a series of curated customized views further comprises, via the user interface application, allowing one particular type of user accessing from one of the plurality of networked computing devices and having a higher access privilege to navigate to and view a first set of customized views for the particular type of user and a second set of other customized views for other types of users having a lower access privilege.

4. The computing device of claim 3, wherein, via the user interface application, the instructions further cause the computer to present a hyperlink on the first set of customized views for the particular type of user to navigate to connected view pages of the other types of users to trigger displaying the second set of other customized views.

5. The computing device of claim 1, wherein the instructions further cause the computer to predict the content interests of each user based on tracking, via the user interface application, online user behavior with a computing device, comprising social media feed associated with the user and prior content navigated to by each user via the user interface application.

6. The computing device of claim 1, wherein the instructions causing the computer to determine the type of user comprises determining an associated role within an entity and retrieving associated digital access levels for accessing each type of a plurality of types of potential data from the set of data.

7. The computing device of claim 1, wherein the instructions causing the computer to generate the curated customized views for a user associated with one of the plurality of networked computing devices further comprises generating at least some screens of content overlapping with content in customized views of the data for another user of a different associated group for an entity based on the access privileges.

8. A method for providing curated customized views of a set of data to a plurality of networked computing devices via a computerized user interface application, the method comprising:
receiving an input, from a database, of an organization chart providing a branched architecture within an entity for a plurality of users associated with the plurality of networked computing devices;
determining from the organization chart each type of user from the plurality of users associated with each of the networked computing devices and thereby accessing a corresponding access chart for the plurality of users comprising access privileges for the users according to the type of user;
determining from the organization chart an associated grouping of the user to other similar users within the entity for each of the plurality of users and thereby accessing content interests specific for both the user and the other similar users;
applying the organization chart to a user interface module for generating a series of curated customized views of the data for each user being a subset visual representation of the data for the computerized user interface application based on the access privileges and the content interests for the user and the other similar users, wherein the curated customized views provide slices of information being related content from the data; and
providing the series of curated customized view of the data across a networked environment, via the user interface application, for different types of users for display on the plurality of networked computing devices.

9. The method of claim 8, wherein the curated customized views for a user have at least some screens of content overlapping with content in customized views of the data for another user of a different associated grouping for an entity based on the access privileges.

10. The method of claim 9, wherein determining a series of curated customized views further comprises, via the user interface application, allowing one particular type of user accessing from one of the plurality of networked computing devices and having a higher access privilege to navigate to and view a first set of customized views for the particular type of user and a second set of other customized views for other types of users having a lower access privilege.

11. The method of claim 10, wherein, via the user interface application, the method further comprises presenting a hyperlink on the first set of customized views for the particular type of user to navigate to connected view pages of the other types of users to trigger displaying the second set of other customized views.

12. The method of claim 8, further comprising predicting the content interests of each user based on tracking, via the user interface application, online user behavior with a computing device, comprising social media feed associated with the user and prior content navigated to by each user via the user interface application.

13. The method of claim 8, wherein determining the type of user comprises determining an associated role within an entity and retrieving associated digital access levels for accessing each type of a plurality of types of potential data from the set of data.

14. The method of claim 8, wherein generating the curated customized views for a user associated with one of the plurality of networked computing devices comprises generating at least some screens of content overlapping with content in customized views of the data for another user of a different associated group for an entity based on the access privileges.

15. A non-transitory computer readable medium having instructions tangibly stored thereon for providing curated customized views of a set of data to a plurality of networked computing devices via a computerized user interface application, wherein the instructions, when executed by at least one processor of a computer system cause the computer system to:
receive an input, from a database, of an organization chart providing a branched architecture within an entity for a plurality of users associated with the plurality of networked computing devices;
determine from the organization chart each type of user from the plurality of users associated with each of the networked computing devices and thereby accessing a corresponding access chart for the plurality of users comprising access privileges for the users according to the type of user;
determine from the organization chart an associated grouping of the user to other similar users within the entity for each of the plurality of users and thereby accessing content interests specific for both the user and the other similar users;
apply the organization chart to a user interface module for generating a series of curated customized views of the data for each user being a subset visual representation of the data for the computerized user interface application based on the access privileges and the content interests for the user and the other similar users, wherein the curated customized views provide slices of information being related content from the data; and
provide the series of curated customized view of the data across a networked environment, via the user interface application, for different types of users for display on the plurality of networked computing devices.
